(19) United States
(12) Patent Application Publication
(10) Pub. No.: US 2014/0270597 A1
(43) Pub. Date: Sep. 18, 2014

(54) PACKAGE WITH RESEALABLE OPENING

(71) Applicant: MARS, INCORPORATED, Hackettstown, NJ (US)

(72) Inventors: Robert Friedman, Hackettstown, NJ (US); Jason Dudek, Hackettstown, NJ (US)

(73) Assignee: MARS, INCORPORATED, Hackettstown, NJ (US)

(21) Appl. No.: 14/211,222

(22) Filed: Mar. 14, 2014

Related U.S. Application Data
(60) Provisional application No. 61/793,038, filed on Mar. 15, 2013.

(51) Int. Cl. B65D 75/58; B31B 19/62

(52) U.S. Cl. CPC B65D 75/5855; B31B 19/62; B31B 2221/50
USPC 383/203; 53/476; 493/264

(57) ABSTRACT

A package with a resealable opening is provided. In one embodiment, the resalable opening includes a lid that may be peeled from the packaging to expose an opening and an adhesive area. The lid may later be adhered back to the packaging by contacting a portion of the lid with the adhesive area.

### BACKGROUND

The present invention generally relates to a packaging. More particularly, the present invention relates to a resealable packaging for flexible packages such as bags.

Prior art resealable packaging for flexible bags typically either lacks easy-open features or use zippers. However, using zippers may be expensive. For example, the packaging including the zipper may typically cost more to purchase. Additionally, packaging including zippers may require additional process steps to package or require the use of specialty machinery.

### SUMMARY

One or more embodiments of the present invention provide a resealable package or bag wherein the opening to the bag may be resealed after the bag is opened. In one embodiment, the resalable opening includes a lid that may be peeled from the packaging to expose an opening and an adhesive area. The lid may later be adhered back to the packaging by contacting a portion of the lid with the adhesive area. In another embodiment, the package includes a peeling structure that may be peeled and discarded to reveal the opening into the bag and an adhesive area. The bag may then be resealed by contacting a portion of the bag with the adhesive area.

### BRIEF DESCRIPTION OF THE DRAWINGS

FIGS. 1A-1B illustrates a resealable bag according to an embodiment of the present invention.

FIGS. 2A-2C illustrates an alternative embodiment of a resealable bag or pouch.

FIGS. 3A-3C illustrates an alternative embodiment of a resealable bag similar to that of FIGS. 2A-2C.

### DETAILED DESCRIPTION OF THE INVENTION

FIGS. 1A-1B illustrates a resealable bag 100 according to an embodiment of the present invention. The resealable bag 100 includes a lap seal 110. The lap seal structure 110 includes a lid 120, a detachment line 130, a lid attachment region 140, a pull tab 150, and a resealable adhesive area 160.

In operation, the resealable bag 100 may be opened by a user by grasping the pull tab 150 of the lid 120 and pulling the pull tab 150 up and away from the rest of the packaging. As the pull tab 150 is pulled, the lid 120 separates along the detachment line 130 to allow the resealable bag 100 to open.

Additionally, as the pull tab 150 is pulled away, it exposes the resealable adhesive area 160 that includes an adhesive, preferably a, resealable adhesive such as a pressure sensitive adhesive. To re-close or re-seal the resealable bag 100, the lid 120 is folded so that the pull tab 150 contacts and adheres to the adhesive in the resealabale adhesive area 160.

The lap seal 110 may be formed by placing an adhesive on the surface of the packaging and then folding the material onto itself and activating the adhesive by heat, pressure, etc. In some embodiments, the lid 120 of the resealable bag 100 can include more than one type of adhesive. One of the adhesives used in this context is typically a permanent (or more permanent or stronger) adhesive rather than the resealable adhesive applied in the resealable adhesive area 160 and is intended in one embodiment to make a permanent seal between at least a portion of the lid and the surface of the packaging. In an alternative embodiment, a more resealable adhesive may be employed.

At the detachment line 130 the structure of the lid is preferably weakened so that the lid separates along the detachment line when the pull tab 150 is pulled. For example, the detachment line may be formed by perforation, laser scoring or scouring, or mechanical scoring or scouring.

Additionally, as the resealable bag 100 is opened and the lid 120 separated along the detachment line 130, some adhered portions 170 of the lid 120 remain adhered to the surface of the packaging as shown in FIG. 1B. In one embodiment, the adhered portions 170 may serve as tamper evidence for the resealable bag 100. For example, when it is observed that adhered portions 170 have been separated from the remainder of the lid 120, it is apparent that the resealable bag has been opened or otherwise tampered with.

In one embodiment of the resealable bag 100, the resealable bag 100 is a flexible package with a lap seal and two laser-scored lines of weakness extending diagonally out from the edge of the lap seal to the side of package and a tab area in the lap seal located in between the two lines of weakness. The resealable bag 100 is formed from a laminate made of at least two layers with a pressure sensitive adhesive located in between the layers in the tab area. When a consumer pulls up on the tab, the top layer of laminate is removed revealing the pressure sensitive adhesive. The lap seal material located under the area defined by the weakened lines remains behind to indicate tamper evidence. The consumer may then reseal the pack by pressing the tab on the pressure sensitive adhesive.

Further, although the term “detachment line” is employed above, the detachment structure may alternatively have another shape such as a curve.

FIGS. 2A-2C illustrates an alternative embodiment of a resealable bag 200 or pouch. The resealable bag 200 includes a fin seal 210, an end seal 220, and a peeling structure 230. The peeling structure 230 includes a pull tab 240, an opening area 250, and an adhesive area 260. FIG. 2B also shows an opening 254 and a pressure sensitive adhesive 264.

In operation, a user grasps the pull tab 240 and uses the pull tab 240 to pull the peeling structure 230 away from the resealable bag 200. As the peeling structure 230 pulls away, the resealable bag is opened by exposing the opening 254. At the same time, the pressure sensitive adhesive 264 is also exposed. When a user continues to pull the pull tab 240, the peeling structure 230 eventually becomes disengaged from the resealable bag 200 and is preferably discarded.

To reseal the resealable bag 200, the user folds over the top portion of the resealable bag 200 including the end seal 220 until the top portion of the bag contacts the pressure sensitive adhesive 264 and adheres to the pressure sensitive adhesive to reseal the resealable bag 200.

Although FIG. 2B illustrates the pressure sensitive adhesive 264 as extending substantially the same length across the resealable bag as the opening area 250, the pressure sensitive adhesive may be configured to occupy a lesser or greater vertical or horizontal extent. For example, the pressure sensitive adhesive may alternatively include a circular or ovoid region near the center of the resealable bag.

In one embodiment, the resealable bag 200 may be a flexible package with an opening area and a reseal area. The opening area may form an opening in the package when a consumer peels and discards the laminate defined by laser scoring in the opening area. The reseal area may include a pressure sensitive adhesive which is revealed when the top layer of the laminate is removed. The opening and reseal areas may have a single tab so that they are removed/opened together or they may have separate tabs. The package may be resealed by folding down the nearest end seal.

FIGS. 3A-3C illustrates an alternative embodiment of a resealable bag similar to that of FIGS. 2A-2C. However, the embodiment of FIG. 3 has a side gusset 370 at one or more ends of the resealable bag. Otherwise, the resealable bag may be opened and reclosed using a peeling structure as shown similar to that of FIGS. 2A-2C.

Although the term “resealable bag” has been used herein, it may alternatively be called packaging, pouch, wrapping, box, or carton.

Further, in one or more embodiment, consumers may be encouraged to use the opening features by having straight (non-serrated) edges on the seals.

In one embodiment, a resealable flexible package is provided that includes an end seal and a peeling structure with an opening area and an adhesive area wherein the peeling structure may be peeled away from the resealable flexible package to create an opening into the interior of the flexible package and to expose a pressure sensitive adhesive. In this embodiment, the resealable flexible package may be resealed by contacting the end seal to the pressure sensitive adhesive to adhere the end seal of the resealable flexible package to the pressure sensitive adhesive.

Alternatively, the end seal may be replaced with some other type of seal such as a fin seal, for example. Additionally, the resealable flexible package may be resealed by contacting some portion of the package other than the end seal to the pressure sensitive adhesive. For example, depending on the configuration of the package, some other exterior or interior portion of the package may be contacted to the pressure sensitive adhesive.

In one embodiment of making a resealable flexible package, the process may proceed by receiving a flexible packaging to be formed into a reseable flexible package, the flexible packaging including an opening to the interior of the flexible packaging, placing adhesive at a first adhesive location on the flexible packaging proximal to the opening; placing adhesive at a second adhesive location on the flexible packaging at an additional location on the exterior or the flexible packaging, positioning one or more peeling structures over the first adhesive location and the second adhesive location, wherein the peeling structure is peelable from the first adhesive location to expose the opening and from the second adhesive location to expose the adhesive, and forming an end seal of an end of the flexible packaging, wherein the flexible packaging may be configured to bring the end seal into contact with the adhesive at the second location to seal the package.

In another embodiment of making a resealable flexible package, the process may proceed by receiving a flexible packaging to be formed into a reseable flexible package, the flexible packaging including an opening to the interior of the flexible packaging, placing adhesive at an adhesive location on the flexible packaging proximal to the opening, and forming a lap seal by lapping one part of the flexible packaging forming a lid over the opening and adhering the lid to an adhesive at an adhesive location on the exterior of the flexible packaging, wherein a first region of the lid is detachable from a second region of the lid, wherein the first region of the lid is peelable from the first adhesive location to expose the opening, wherein the second region of the lid detaches from the first region of the lid and remains adhered to the adhesive location when the first region is peeled, wherein the lid may be later brought into contact with the adhesive location to seal the flexible package.

While particular elements, embodiments, and applications of the present invention have been shown and described, it is understood that the invention is not limited thereto because modifications may be made by those skilled in the art, particularly in light of the foregoing teaching. It is therefore contemplated by the appended claims to cover such modifications and incorporate those features which come within the spirit and scope of the invention.

1. A resealable flexible package including:
an end seal and a peeling structure with an opening area and an adhesive area wherein the peeling structure may be peeled away from the resealable flexible package to create an opening into the interior of the flexible package and to expose a pressure sensitive adhesive,
wherein said resealable flexible package may be resealed by contacting said end seal to said pressure sensitive adhesive to adhere said end seal of said resealable flexible package to said pressure sensitive adhesive.

2. A method for resealing a resealable flexible package, said method including:
engaging a pull tab on a lid in order to create an opening in the resealable flexible package and to expose a pressure sensitive adhesive;
resealing the resealable bag by bringing an end seal of said resealable flexible package into contact with said pressure sensitive adhesive, wherein said end seal of said resealable flexible package adheres to said pressure sensitive adhesive.

3. A resealable flexible package including: a lap seal wherein the lap seal includes a lid and at least one detachment line and wherein the lid includes a resealable adhesive area.

4. The resealable flexible package of claim 3 wherein the lap seal includes a permanent adhesive.

5. A method of making a resealable flexible package, said method including:
receiving a flexible packaging to be formed into a reseable flexible package, said flexible packaging including an opening to the interior of said flexible packaging;
placing adhesive at a first adhesive location on said flexible packaging proximal to said opening;
placing adhesive at a second adhesive location on said flexible packaging at an additional location on the exterior or said flexible packaging;
positioning one or more peeling structures over said first adhesive location and said second adhesive location, wherein said peeling structure is peelable from said first adhesive location to expose said opening and from said second adhesive location to expose said adhesive;
forming an end seal of an end of said flexible packaging, wherein said flexible packaging may be configured to bring said end seal into contact with said adhesive at said second location to seal said package.

6. A method of making a resealable flexible package, said method including:
receiving a flexible packaging to be formed into a reseable flexible package, said flexible packaging including an opening to the interior of said flexible packaging;
placing adhesive at an adhesive location on said flexible packaging proximal to said opening; and
forming a lap seal by lapping one part of said flexible packaging forming a lid over said opening and adhering said lid to an adhesive at an adhesive location on the exterior of said flexible packaging,
wherein a first region of said lid is detachable from a second region of said lid,
wherein said first region of said lid is peelable from said first adhesive location to expose said opening,
wherein said second region of said lid detaches from said first region of said lid and remains adhered to said adhesive location when said first region is peeled,
wherein said lid may be later brought into contact with said adhesive location to seal said flexible package.
